(19) United States
(12) Patent Application Publication
(10) Pub. No.: US 2002/0192069 A1
(43) Pub. Date: Dec. 19, 2002

(54) Wind machines

(76) Inventor: Edwin Newman, Northridge, CA (US)

Correspondence Address: Edwin Newman, 10331 Lindley Ave. #113, Northridge, CA, 91326, US

(21) Appl. No.: 09/880,142

(22) Filed: Jun. 14, 2001

(51) Int. Cl. F03D 1/04

(52) U.S. Cl. 415/4.1; 415/2.1; 415/4.2; 415/4.4

(57) ABSTRACT

Wind machines are disclosed in which the pressure energy of the wind is converted into electrical energy. A nozzle unobstructed by any turbine or propeller bearing a significant load is made to face the wind. The nozzle converts the pressure energy of the wind into kinetic energy. In one embodiment a turbine is disposed around the throat of the nozzle and air sucked through the turbine and exhausted through the throat of the nozzle. An obstruction at the turbine inlets is placed in such a way as to cause a pressure variation on either side of the obstruction, causing the turbine to rotate. In a second embodiment a small turbine within the throat of the nozzle is made to revolve several three way ball valves. These valves open and close passage-ways so as to admit or evacuate air from one side of pistons in cylinders of an atmospheric engine. The low pressure in the volume of the nozzle throat serves as an energy sink. The other side of the pistons are open to the atmosphere.

### BACKGROUND AND SUMMARY OF THE INVENTION

1. Field of the Invention

The present invention relates to the conversion of wind energy into electrical energy. In particular the invention relates to the conversion of pressure energy of the wind into electrical energy.

2. Background and Summary

Wind possesses mechanical energy. The two relevant components of mechanical energy are kinetic energy and pressure energy. Up to now only the kinetic energy of the wind has been considered for conversion into electrical energy. Yet it is apparent that the pressure energy of the wind is far greater than its kinetic energy. Nozzles convert pressure energy of the wind into useable kinetic energy but placing nozzles to the windward side of wind turbines and propellers has not proved satisfying. In great variety such U.S. Patents such as Jander, U.S. Pat. No. 1,209,301, Sellman U.S. Pat. No. 3,986,786, Hope et al. U.S. Pat. No. 4,088,419, Bergstein U.S. Pat. No. 4,960,363 and Les Strange U.S. Pat. No. 6,043,565 show turbines or propellers directly in the in the path of the wind within the throat of the nozzle. This placement causes turbulence and a consequent loss of efficiency.

The present invention avoids this problem by placing an air reaction turbine concentrically around the outside wall of the throat of the nozzle. Maximum pressure of the turbine is one atmosphere. The exhaust air is evacuated through the low pressure of the nozzle throat as the air is made to pass through it. Air moving at high speed through the nozzle throat is made to suck air through the turbine causing it to produce power.

A second preferred embodiment is based on the technology of U.S. patent application Ser. No. 09/477,603 which uses subsurface ocean currents instead of wind. A nozzle is made to intercept the water flow. Within the throat of the nozzle is a small tangential turbine with no significant load on it. Accellerating fluid current through the nozzle causes the turbine to operate a rotary valve in a pipe system with three connections: the first is an open passage to the ocean outside, the second is an open passage from the throat of the nozzle and through the wall of the body of the rotary valve. The third is an open passage to a steel chamber's interior which is completely lined on its inside walls with piezoelectric elements. The rotary valve is made to turn by the turbine. This action varies the pressure on the piezoelectric elements. The intermittent high pressure on the piezoelectric elements is made to be expelled into the low pressure volume which is the throat of the nozzle. The resulting variation in pressure causes voltage to be produced by the piezoelectric elements which is then collected in a manner well known in the art and sent to shore by electric cable.

A piezoelectric system is used since the use of an alternator or generator is inappropriate for underwater applications. But the maximum pressure is the ambient pressure underwater. Likewise the maximum pressure for the present invention is the ambient pressure: one atmosphere.

The first steam engines as patented by Savery(English patent 356 issued in 1698 and developed by Newcomen also a maximum pressure of one atmosphere. One side of a piston within a cylinder is left open to atmospheric pressure. on the other side of the piston steam at atmospheric pressure is introduced and periodically condensed, leaving a vacuum. Atmospheric pressure on the first side of the piston will thus move the piston and cause the piston to do work.

The variations in pressure caused by operating the mentioned rotary valve may be used to operate an atmospheric engine where the working fluid is air, not steam. In the second preferred embodiment this is done. Two pistons on a single crankshaft are made to operate transmission gears to vary the output speed. These gears are shafted to an A.C. alternator to convert mechanical energy to electric energy.

To summarize the objects of the invention: (1). to overcome the practical objections to the use of a nozzle to collect wind energy for conversion to electric energy, and(2)to utilize the familiar technologies of atmospheric engines and A.C. alternators to convert the pressure energy of the wind into electric energy. The attainment of the foregoing and related objects, features and advantages of the invention should be more readily apparent to those skilled in the art after the review of the following more detailed description of the invention, taken together with the drawings, in which:

### BRIEF DESCRIPTION OF THE DRAWINGS

FIG. 1 is a perspective view of the first preferred embodiment of the invention.

FIG. 1a. is a perspective view of one of the turbine inlets shown in FIG. 1

FIG. 2 is a perspective view of the second preferred embodiment of the invention.

### DETAILED DESCRIPTION OF THE INVENTION

### First Preferred Embodiment

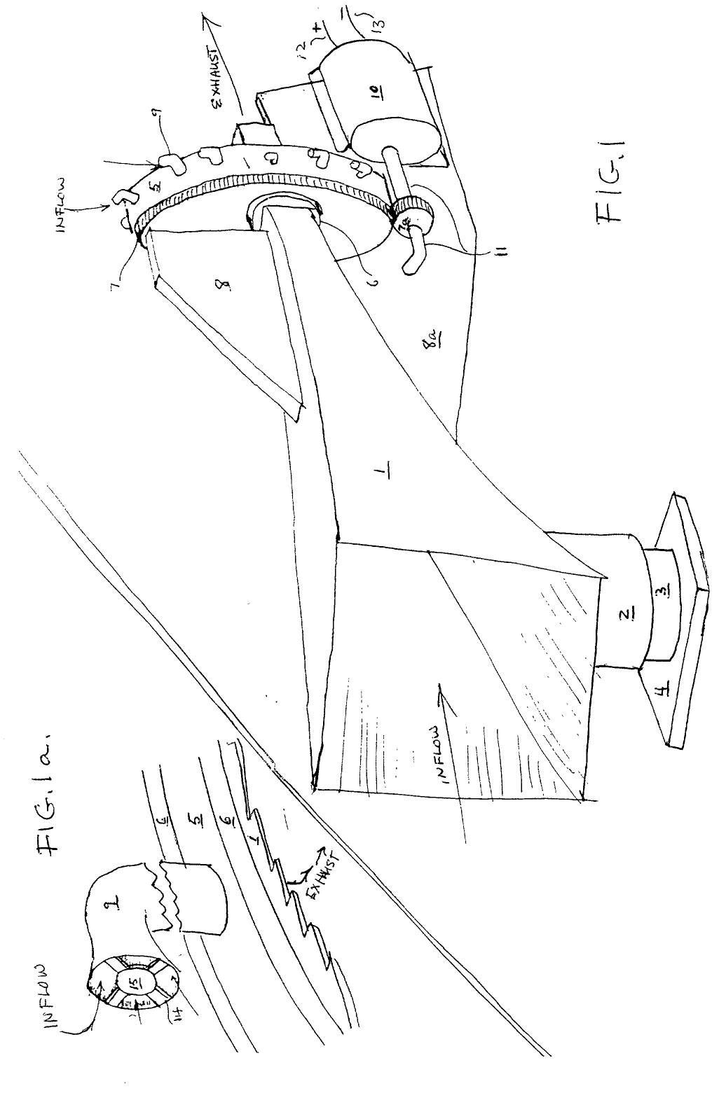

Turning to FIG. 1 there is shown a nozzle 1 mounted on a telescopic tube 2, 3 affixed to a base 4. Between sections 2 and 3 are thrust bearings (not shown) so nozzle 1 may revolve about tube section 3. Around the throat of nozzle 1 is disposed a turbine 5. In FIG. 1a there is shown thrust bearing 6 attached fixedly to both turbine 5 and nozzle 1. Turbine inflow pipe 9 is bent so the end is normal to the direction of rotation of turbine 5. The inflow end of inflow pipe 9 is partly covered by disc 14 fixedly attached to the rim of inflow pipe 9 by connectors 15. The outer surface of disc 14 is level with the rim of pipe 9. The area defined by pipe rim connectors 15 and disc 14 through which air flows should be at least equal to the cross-sectional area of inflow pipe 9.

Again in FIG. 1 there is shown a plurality of inflow pipes 9 disposed around the circumference of turbine 5. Fixedly attached to turbine 5 is spur gear 7 which is made to mesh with smaller spur gear 7a. Nozzle 1 has rudders 8, 8a fixedly attached. To rudder 8a are attached gear 7a, shaft 11, alternator 10 and circuit wires 12, 13.

In operation, wind at atmospheric pressure enter nozzle 1 is accellerated and is made to exit the throat of nozzle 1. As the passage ways from turbine inflow pipes 9 to the throat of nozzle 1 are open air is sucked through these pipes. This causes a pressure difference on either side of disc 14 which causes turbine 5 and spur gear 7 to revolve. Spur gear 7a and the armature of alternator 10 through the agency of shaft 11 are thus made to revolve, causing voltage to be produced in circuit wires 12, 13.

### Second Preferred Embodiment

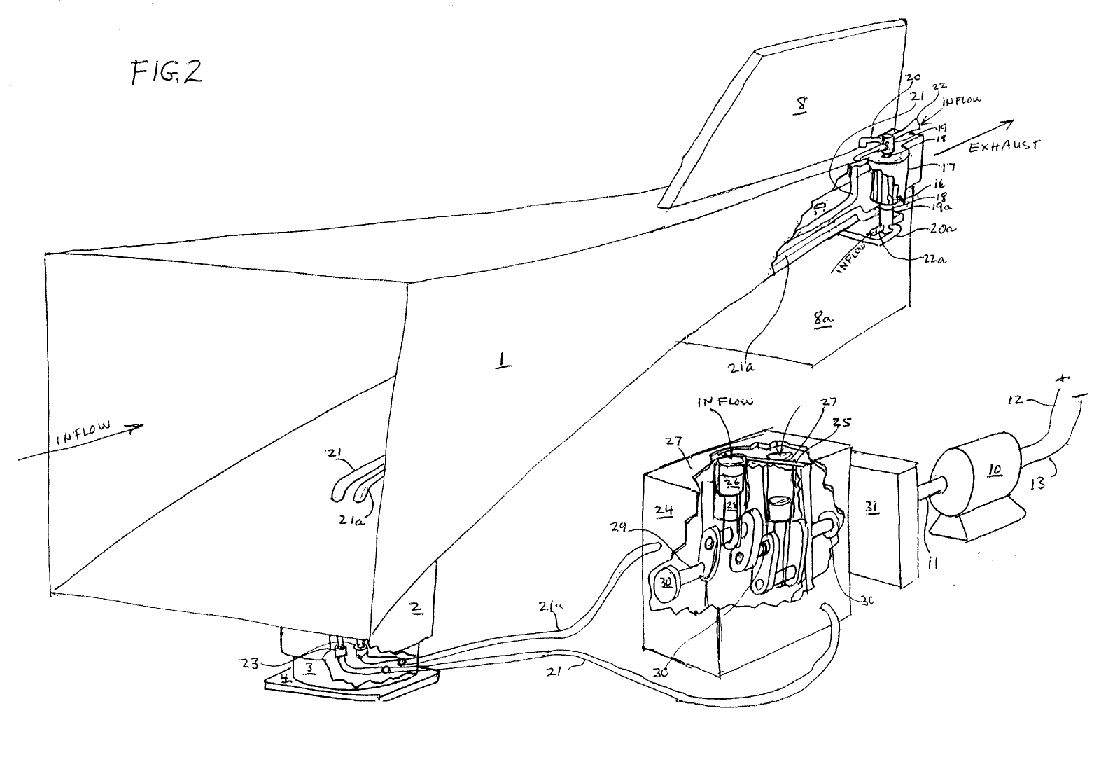

Turning to FIG. 2 there is shown a base 4. Firmly fixed to base 4 is a cylindrical tower 3. Fitting telescopically over tower 3 is a larger tower 2. which is fixedly attached to nozzle 1. As in the first preferred embodiment thrust bearings fitted between cylinders 2, 3 allow nozzle 1 to be freely rotated. Within the throat of nozzle 1 is turbine 16 within recess wall 17 and mounted on shaft 18. This is a tangential turbine whose blade tips only extend into the throat a small distance. At the ends of shaft 18 are two 3-way ball valves 19, 19a whose rotors are fixedly attached to shaft 18 and whose bodies are fixedly attached to nozzle 1. Pipes 20, 20a are passageways from the throat of nozzle 1 to an opening in the bodies of valves 19, 19a respectively. Pipes 22, 22a are passageways leading from valves 19, 19a respectively extending through rotateable gas seals 23 to the volumes on either side of wall 25 of airtight container 24. Within container 24 is crankshaft 29 mounted on ball bearings 30 to the walls of container 24. Wall 25 is also airtight, dividing container 24 into two airtight volumes. Mounted on crankshaft 29 are piston rods 28, pistons 26, and piston cylinders 27 whose tops open to atmospheric pressure. Crankshaft 29 is connected to gears 31, shaft 11 and alternator 10.

In operation, turbine 16 is made to revolve by the wind accellerating through nozzle 1. Turbine 16 is made to rotate the rotors of valves 19, 19a. During a first half of rotation air is made to be sucked out of a first volume of container 24 through pipe 21, valve 19 and pipe 20, and exhausted through the throat of nozzle 1. At the same time air at atmospheric pressure is introduced into the other volume of container 24through pipe 22a, valve 19a and pipe 21a. During a second half of rotation of the rotor of valve 19 pipes 21a, 22a are closed and air is made to move at atmospheric pressure through pipes 21, 22 into the first volume of container 24. At the same time air at atmospheric pressure is sucked out of the second volume of container 24, through pipe 21a, valve 19a and pipe 20a exhausted through the throat of nozzle 1. As air on the side of the pistons 26 further from crankshaft 29 is always at atmospheric pressure then pistons 26 will be made to revolve crankshaft 29, gears 31, shaft 11 and operate alternator 10.

From the above description it is apparent that the preferred embodiments achieve the objects of the present invention. Altered native embodiments and various modifications of the depicted embodiments will be apparent to those skilled in the relevant arts. These and other alternatives are considered to be equivalent and within the spirit and scope of the present invention.

What is claimed is:

5. A system for converting the pressure energy of the wind into electrical energy, the system comprising:
a. a conversion means for converting pressure energy into kinetic energy,
b. a turbine with two types of inlet and a common outlet, one type open to the atmosphere and the other type open to to said conversion means and the kinetic energy produced by said conversion means,
c. connection means between said turbine and said conversion means,
d. an alternator means, and
e. shaft means between said turbine and said alternator means so said turbine is made to operate said alternator means.

6. The system as in claim 5 wherein said conversion means is a nozzle.

7. The system as in claim 5 wherein said turbine further includes a number of fluid passageways with inlets and outlets, a number of said fluid inlets disposed around the circumference of said turbine, said inlets' openings positioned as being normal to the rotational axis of said turbine and partly obstructed by discs attached to the rims of said openings, and a number of said fluid outlets located next to said wind flowing through said conversion means so as fluid is made to pass said discs a pressure difference is created on either side of said discs causing said turbine to rotate normal to said rotational axis.

8. The system in claim 5 wherein said connection means comprises thrust bearings attached to said turbine so said fluid outlets are positioned next to and disposed concentrically around an end of said conversion means.

9. A system for conversion of the pressure energy of the wind into electrical energy, the system comprising:
a. a conversion means for converting pressure energy into kinetic energy,
b. an atmospheric engine operated by the introduction of air into said engine at atmospheric pressure and by said air's evacuation which is caused by the kinetic energy of air produced by said conversion means,
d. shafting means between said atmospheric engine and said alternator means so said atmospheric engine is made to operate said alternator means, and
e. a valve and pipe means for alternating said introduction and evacuation of said air through said atmospheric engine.

10. The system of claim 9 wherein said conversion means is a nozzle.
